(19) United States
(12) Patent Application Publication
(10) Pub. No.: US 2022/0214640 A1
(43) Pub. Date: Jul. 7, 2022

(54) STRUCTURE FOR CLEANING SENSOR

(71) Applicant: Hewlett-Packard Development Company, L.P., Spring, TX (US)

(72) Inventors: Sangcheol KIM, Seongnam-si (KR); Jewon JEONG, Seongnam-si (KR)

(21) Appl. No.: 17/612,027

(22) PCT Filed: Mar. 27, 2020
(86) PCT No.: PCT/US2020/025281

§ 371 Date: Nov. 17, 2021

(30) Foreign Application Priority Data
Oct. 29, 2019 (KR) 10-2019-0135885

(51) Int. Cl. G03G 21/00

(52) U.S. Cl. CPC G03G 21/00

(57) ABSTRACT

A sensor cleaning device to clean a sensor to detect a printable medium on a transferring path. The sensor cleaning device includes a cleaning lever, and a driver. The cleaning lever is coupled to a cleaner at an end of the cleaning lever. The driver is coupled to the cleaning lever and is to drive the cleaning lever to move the cleaner from a first position to a second position and back to the first position, the first position being away from the transferring path and the second position being in contact with the sensor.

### BACKGROUND

An image forming apparatus is an apparatus for generating, printing, receiving, or transmitting image data. Examples of the image forming apparatus include a printer, a scanner, a copy machine, a fax machine, and a multifunction printer integrating these functions.

The image forming apparatus is equipped with a plurality of sensors for sensing a size, a position, a material, etc. of a printing paper. During the printing process, dust generated from printing paper or the like may contaminate the sensor.

### BRIEF DESCRIPTION OF THE DRAWINGS

FIG. 1 is a cross-sectional view illustrating an image forming apparatus according to an example.

FIG. 2 is a perspective view illustrating a detection apparatus provided with a sensor cleaning device according to an example.

FIG. 3 is a block diagram of an image forming apparatus according to an example.

FIG. 4 is a side view illustrating a detection apparatus provided with a sensor cleaning device according to an example.

FIG. 5 is a partial perspective view illustrating a detection apparatus provided with a sensor cleaning device according to an example.

FIG. 6 is a partial enlarged perspective view illustrating a sensor cleaning device according to an example.

FIG. 7 and FIG. 8 are partial exploded perspective views illustrating a sensor cleaning device according to an example.

FIG. 9A and FIG. 9B are cross-sectional view views illustrating operations of a sensor cleaning device according to an example.

FIG. 10A and FIG. 10B are drawings illustrating a driver applicable to of a sensor cleaning device according to an example.

### DETAILED DESCRIPTION

As those skilled in the art will realize, the following described examples may be modified in various different ways, all without departing from the spirit or scope of the present disclosure. In order to clarify the present disclosure, parts that are not relevant to the description will be omitted, and the same elements or equivalents are referred to by the same reference numerals throughout the specification. Each of the size and thickness of each element is arbitrarily shown in the drawings and the present disclosure is not necessarily limited thereto. In the drawings, the thickness of layers, films, panels, regions, etc., may be exaggerated for clarity.

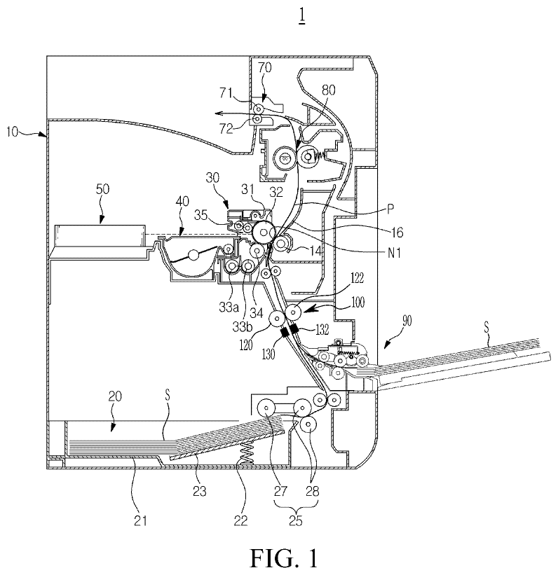

FIG. 1 is a cross-sectional view illustrating an image forming apparatus according to an example.

As shown in FIG. 1, an image forming apparatus 1 may include a main body 10, first and second printing medium supply devices 20 and 90 for storage and for supplying of printing medium S, a developing device 30 to form an image on each printing medium S supplied via the first and second printing medium supply devices 20 and 90, a toner device 40 to feed toner to the developing device 30, a light scanning device 50 to form an electrostatic latent image on a photoconductor 32, a fixing device 80 to fix a toner image transferred onto the printing medium S to the printing medium S, and a printing medium discharge device 70 to discharge the printing medium S on which the image has been completely formed to the outside of the main body 10.

The first printing medium supply device 20 may store and supply the printing medium S, and may be located below the main body 10 to supply the printing medium S to the developing device 30.

The printing medium supply device 20 may include a printing medium cassette 21 to be withdrawn from the main body 10 to store the printing medium S, and a delivery member 25 to pick up the printing medium S stored in the printing medium cassette 21 one by one and deliver the same to the developing device 30.

To guide the loaded printing medium S to the delivery member 25, a knock-up plate 23 may be installed in the printing medium cassette 21 such that one end of the knock-up plate 23 is rotatably coupled to the printing medium cassette 21 and the other end of the knock-up plate 23 is supported by a pressure spring 22.

The delivery member 25 may include a pickup roller 27 to pick up the printing medium S loaded on the knock-up plate 23 one by one, and a feed roller 28 to deliver each printing medium S picked up by the pickup roller 27 to the developing device 30.

The developing device 30 may include a housing 31 defining an external appearance of the developing device 30, the photoconductor 32 rotatably installed in the housing 31 such that an electrostatic latent image is formed thereon, agitator screws 33a, 33b to agitate toner fed into the toner device 40, a developing roller 34 to feed the toner agitated by the agitator screws 33a, 33b to the photoconductor 32, and a charge member 35 to charge the photoconductor 32.

The toner fed from the toner device 40 may be introduced into the housing 31 and is agitated and delivered to one side of the housing 31 by the agitator screws 33a, 33b. The delivered toner may be fed to the photoconductor 32 by the developing roller 34 to form a visible toner image.

To transfer the visible toner image formed on the photoconductor 32 to the printing medium S, the photoconductor 32 may come into contact with the transfer roller 14 to define a transfer nip N1 with a transfer roller 14. The transfer roller 14 may be rotatably placed within the main body 10.

The toner device 40 may be coupled to the developing device 30 and receive and store toner used to form an image on the printing medium S. The toner device 40 may feed toner to the developing device 30 during an image forming operation.

The light scanning device 50 may emit light including image information to the photoconductor 32 to form an electrostatic latent image on the photoconductor 32.

The fixing device 80 may fix the toner image formed on the printing medium S to the printing medium S by applying heat and pressure to the printing medium S.

The printing medium discharge device 70 may include a first discharge roller 71 and a second discharge roller 72 which are sequentially arranged to discharge the printing medium S having passed through the fixing device 80 to the outside of the main body 10.

A guide rib 16 may be disposed between the transfer nip N1 and the fixing device 80 and may guide the printing medium S to pass through the transfer nip N1 to the fixing device 80. The guide rib 16 may define a portion of a transferring path P of the printing medium S between the transfer nip N1 and the fixing device 80.

The second printing medium supply device 90 may store and feed the printing medium S separately from the first printing medium supply device 20 and may be provided on a side of the main body 10 to supply the printing medium S toward the developing device 30.

A detection apparatus 100 may be interposed between the first and second printing medium supply apparatuses 20 and 90 and the detection apparatus 100 may include a driving roller 120 and a driven roller 122 to transfer the printing medium S.

As an example, the detection apparatus 100 may include a sensor to detect a size, a position or a material, etc. of the printing medium S. The detection apparatus 100 may also include a sensor cleaning device to remove dirt, such as dust, from the sensor.

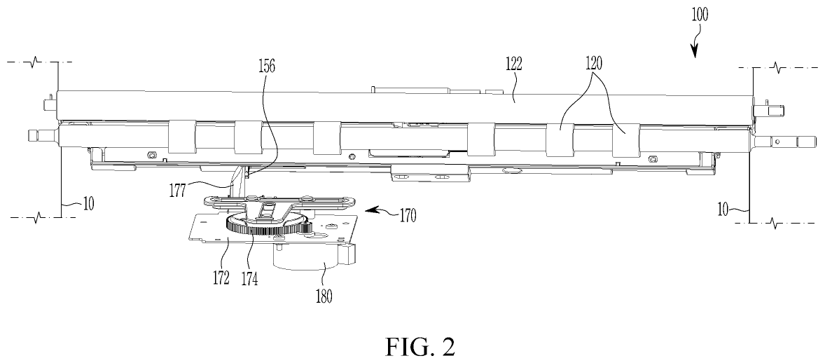

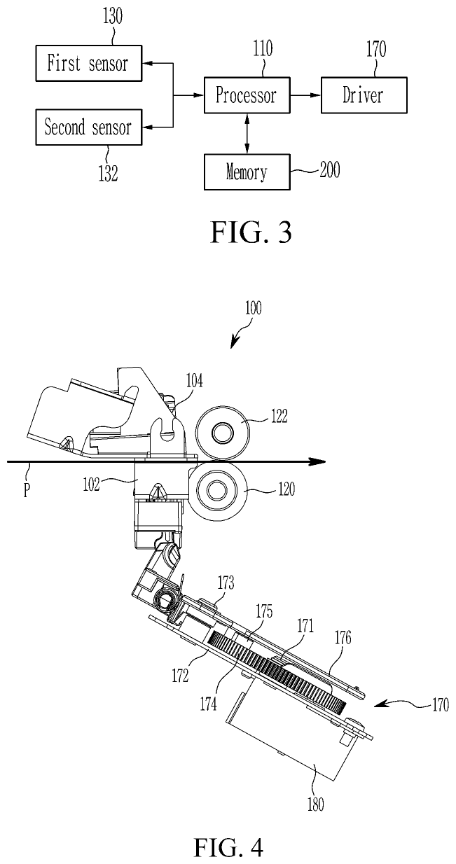

FIG. 2 is a perspective view illustrating a detection apparatus provided with a sensor cleaning device according to an example and FIG. 3 is a block diagram of an image forming apparatus according to an example.

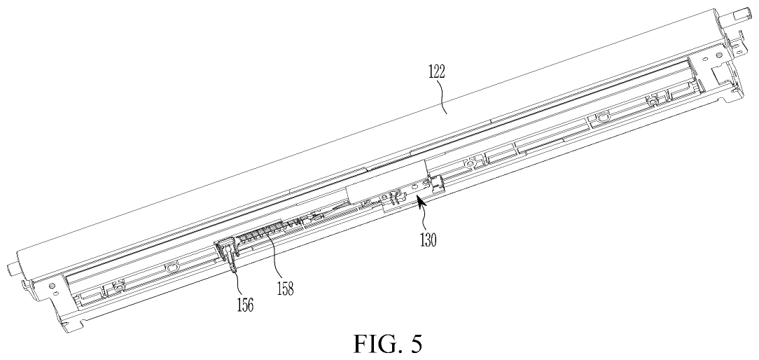

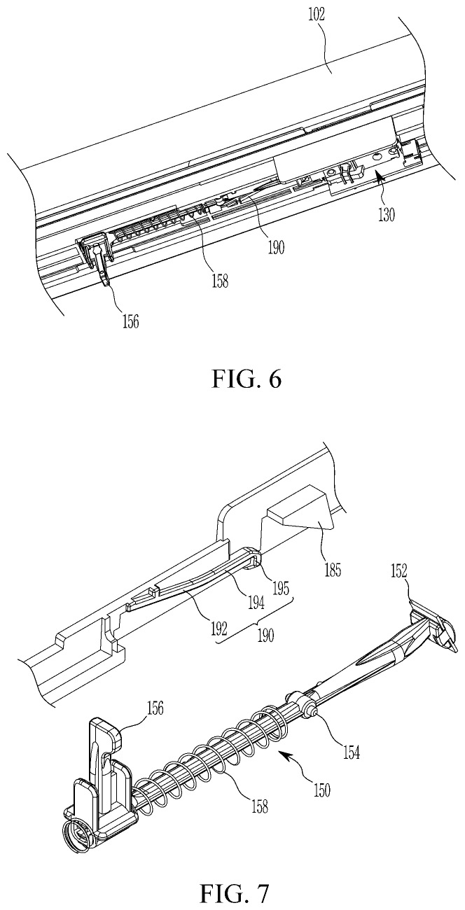

FIG. 4 is a side view illustrating a detection apparatus provided with a sensor cleaning device according to an example and FIG. 5 is a partial perspective view illustrating a detection apparatus provided with a sensor cleaning device according to an example.

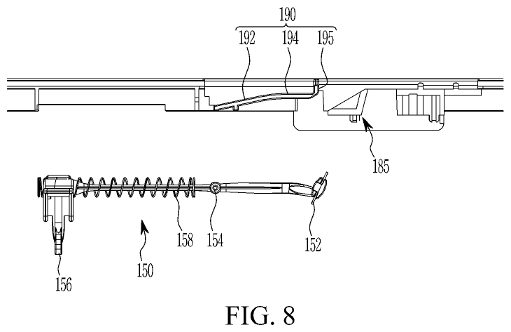

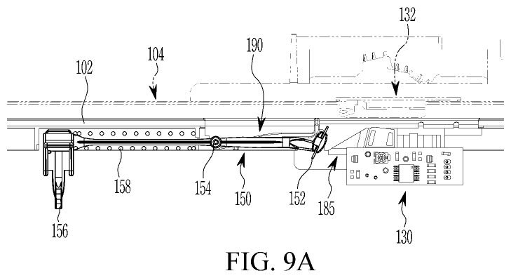

FIG. 6 is a partial enlarged perspective view illustrating a sensor cleaning device according to an example and FIG. 7 and FIG. 8 are partial exploded perspective views illustrating a sensor cleaning device according to an example.

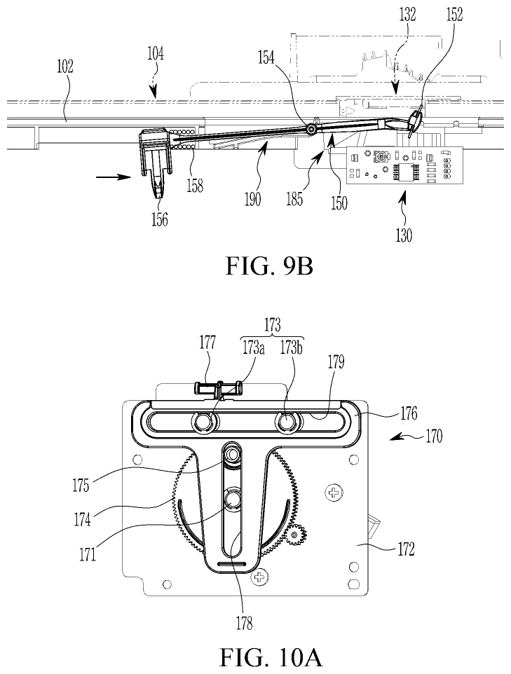

FIG. 9A and FIG. 9B are cross-sectional view views illustrating operations of a sensor cleaning device according to an example.

In describing the sensor cleaning device according to an example of the present disclosure, a sensor cleaning device mounted on a detection apparatus is described as an example for convenience of understanding, but the sensor cleaning device is not limited thereto. The sensor cleaning device can be applied to various configurations.

The detection apparatus according to an example of the present disclosure may include, for example, a pick up unit to move a sheet of the printing medium S from the printing medium cassette 21, a speed adjusting unit to adjust a moving speed of the printing medium S, a registration unit for detecting paper type and/or material and the like.

In describing the detection apparatus according to an example of the present disclosure, for the convenience of understanding, the detection apparatus 100 will be described as an example of a registration unit.

The sensor cleaning device according to an example of the present disclosure is provided to clean a sensor that senses the printing medium S on the transferring path P.

Here, the transferring path P may refer to a path through which the printing medium S moves, as described above.

The sensor cleaning device according to an example of the present disclosure may include a cleaning lever 150 connected with a cleaner 152 at one end and a driver 170 to drive the cleaning lever 150.

The cleaner 152 may move from a first position to a second position and back to the first position, the first position being away from the transferring path P and the second position being in contact with the sensor according to an operation of the driver 170.

The sensor may include a first sensor 130 disposed on one side of the transferring path P and a second sensor 132 disposed on the other side of the transferring path P to face the first sensor 130.

One of the first sensor 130 and the second sensor 132 may be a light emitting portion to irradiate light toward the printing medium S, and the other may be a light receiving portion.

The cleaner 152 may clean the light emitting portion and/or the light receiving portion according to the operation of the driver 170.

The first position, as shown in FIG. 9A, may be defined as a position at which the cleaner 152 and the cleaning lever 150 deviate from the transferring path P so as not to interfere with the movement of the printing medium S.

The second position, as shown in FIG. 9B, may be defined as a position on the transferring path P protruded such that the cleaner 152 cleans the light emitting portion and/or the light receiving portion.

The sensor cleaning device according to an example of the present disclosure may further include a guide rail 190 disposed adjacent to the transferring path P and a guide projection part 154 formed to the cleaning lever 150 in contact with the guide rail 190 to guide movement of the cleaning lever 150.

The guide rail 190 may include a first rail 192 inclined to the transferring path P to protrude the cleaning lever 150 and a second rail 194 parallel to the transferring path P for the cleaner 152 to contact the sensor 130 and/or 132 and clean the sensor 130 and/or 132. In addition, the guide rail 190 may further include a stopper 195 for limiting movement of the cleaning lever 150.

The sensor cleaning device may further include a lever spring 158 providing the cleaning lever 150 with restoring force in the first position direction.

The sensor cleaning device may further include a guide block 185 formed adjacent to the guide rail 190 to guide movement of the cleaner 152.

The cleaner 152 may be made of a cloth material, for example. The material may be made of a flexible material such as felt, woven fabric, non-woven fabric, knit, and band. The material may be a suitable material for removing contaminants of the sensor 130 and/or 132.

The first sensor 130 may be mounted to a first housing 102, and the second sensor 132 facing the first sensor 130 may be coupled to a second housing 104 and the guide rail 190 may be formed inside the first housing 102.

The driving roller 120, the driven roller 122, the first housing 102 and the second housing 104 may be coupled to the main body 10.

The image forming apparatus according to an example of the present disclosure may further include a processer 110 that controls operations of the first sensor 130 and the second sensor 132 and detects an operation state.

The processer 110 may control the operation of the driver 170 such that the cleaner 152 is positioned at the first position when the printing medium S on the transferring path P passes, and may control the operation of the driver 170 such that the cleaner 152 cleans the sensor 130 and/or 132 at the second position when there is no printing medium S on the transferring path P.

For example, the processer 110 may determine whether the printing medium S exists on the transferring path P and control the operation of the driver 170 according to the output signal of the sensor 130 and/or 132.

The image forming apparatus according to an example of the present disclosure may further include a memory 200 communicating with the processer 110.

The processer 110 may determine whether a number of operations stored in the memory 200 exceed a predetermined number of operations, or whether a sensitivity of the light emitting portion or the light receiving portion is less than a predetermined sensitivity.

One of the first sensor 130 and the second sensor 132 may be the light emitting portion, and the other may be the light receiving portion.

The light emitting portion is a light-emitting device that emits light, and may be, for example, a light emitting diode (LED), but is not limited thereto. The light receiving portion may be disposed almost in line with the light path of the light emitted from the light emitting portion and may include a light receiving element that detects an amount of light passing through the printing medium S from the light emitting portion.

The light emitting portion may also include a light receiving element that detects the amount of light reflected from the printing medium S.

The first sensor 130 and the second sensor 132 may be, for example, a reflective type medium sensor, but is not limited.

The light emitting portion and the light receiving portion may detect the type and/or material of the printing medium S, and the printing medium S may be a printing substance of various forms such as a paper, a paperboard, a overhead project film OHP and the like.

The processer 110 may operate the driver 170 when the number of operations stored in the memory 200 exceeds a predetermined number of operations or when the sensitivity of one of the light emitting portion and the light receiving portion is less than the predetermined sensitivity.

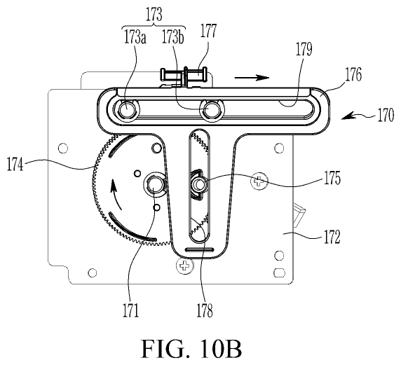

FIG. 10A and FIG. 10B are drawings illustrating a driver applicable to of a sensor cleaning device according to an example.

Referring to FIG. 2, FIG. 4 and FIG. 10, the driver 170 may include a guide plate 176 coupled to a driving lever 177 to drive the cleaning lever 150, of which a driving groove 178 into which a driving shaft 175 is inserted to be movable is formed to the guide plate 176, and the guide plate 176 to be relatively movable to a driving guider 173.

The driving guider 173 may include guide shafts 173a and 173b provided along the first position and the second position directions, and the guide plate 176 may be formed with a guide groove 179 into which the guide shafts 173a and 173b are inserted.

The driving guider 173 is provided on the driving plate 172, and a driving motor 180 is coupled to the driving plate 172. A main gear 174 engaged with the driving motor 180 is rotatably coupled to the driving plate 172 via a rotation axis 171, and the driving shaft 175 is coupled to the main gear 174.

The driving guider 173 and the driving groove 178 may be formed in a perpendicular direction.

Hereinafter, referring to FIG. 1 to FIG. 8, an operation of an image forming apparatus equipped with the sensor cleaning device according to an example of the present disclosure will be described.

When the first driving roller 120 and the driven roller 122 rotate, the printing medium S is supplied in the arrow direction shown in FIG. 4.

Referring to FIG. 2, FIG. 4 and FIG. 9, the first sensor 130 and the second sensor 132 are disposed facing the transfer path P, and detect the printing medium S passing through the transferring path P. For example, the first sensor 130 and the second sensor 132 may be a light emitting portion and a light receiving portion for detecting the size, position or material of the printing medium S.

If the copying or printing operation is continued, the first sensor 130 and the second sensor 132 may be contaminated by debris or dust of the printing medium S. For example, the sensing surfaces of the first sensor 130 and the second sensor 132 are contaminated, and thus a malfunction of the first sensor 130 and the second sensor 132 may occur.

The processer 110 determines whether the number of operations such as copying or printing stored in the memory 200 exceeds the predetermined number of operations. When the number of operations stored in the memory 200 exceeds the predetermined number of operations, the processer 110 may operate the driver 170. For example, if the number of operations stored in the memory 200 exceeds 10,000, it is determined that the sensor needs to be cleaned, and the processer 110 may operate the driver 170. The predetermined number of operations is not limited to this example. If the processer 110 runs the driver 170, the memory 200 may be initialized and applied to a later cleaning operation.

In addition, the processer 110 may determine whether or not the sensitivity of the first sensor 130 and the second sensor 132 is less than the predetermined sensitivity. The processer 110 may operate the driver 170 when the sensitivity of the first sensor 130 and the second sensor 132 is below the predetermined sensitivity. For example, if 10% sensitivity is deteriorated compared to the initial sensor sensitivity or the initial design, the sensor needs to be cleaned and the processer 110 may operate the driver 170. Here, the sensitivity refers to the degree to which the signal output from the first sensor 130 or the second sensor 132 is detected by the second sensor 132 or the first sensor 130, and in case of deteriorated sensitivity, the detection unit of the first sensor 130 and/or the second sensor 132 may determine that contamination has occurred in the first sensor 130 and/or the second sensor 132. The predetermined sensitivity is not limited to one example, and may be preset in order to prevent a malfunction of the sensor.

Here, the processer 110 determines whether the copying or printing operation is not performed. The copying or printing operation is not performed, when the printing medium S does not pass on the transferring path P. When the printing medium S does not pass on the transferring path, then the driver 170 may be operated.

Referring to FIG. 10, when the processer 110 operates the driver 170, the driving motor 180 rotates to rotate the main gear 174 about the rotation axis 171.

Then, the driving shaft 175 coupled to the main gear 174 also rotates about the rotation axis 171.

Since the driving groove 178 into which the driving shaft 175 is inserted is formed in a direction perpendicular to the guide groove 179 and the driving shaft 175 moves relative within the driving groove 178, the guide plate 176 moves along the driving guider 173. That is, the guide plate 176 is moved along the driving guider 173 in the arrow direction in FIG. 10B. Here, the driving guider 173 may include two guide shafts 173a and 173b as shown in the drawing, but is not limited.

When the guide plate 176 moves, the driving lever 177 coupled with the guide plate 176 pushes a lever end 156 formed on the cleaning lever 150.

Then, as shown in of FIG. 9A, the cleaning lever 150 positioned at the first position by the lever spring 158 moves to the second position as shown in of FIG. 9B.

The guide projection part 154 moves along the first rail 192 formed in an oblique direction, and the cleaner 152 protrudes in the first housing 102. The guide projection part 154 then moves along the second rail 194 and the cleaner 152 cleans the sensor. That is, the cleaner 152 cleans at least one of the first sensor 130 and the second sensor 132. The second rail 194 may be formed in a direction parallel to the transferring path P. The stopper 195 contacts the guide projection part 154 to limit the movement of the cleaning lever 150.

The cleaner 152 may be a material of a flexible material such as felt, woven fabric, non-woven fabric, knit, band and the like.

The guide block 185 may be formed to be inclined in an oblique direction, that is, the transferring path P, to guide the movement of the cleaner 152 when the cleaner 152 moves.

Thereafter, the cleaning lever 150 is repositioned to the first position by the restoring force of the lever spring 158, and the cleaning operation may be repeated in an appropriate number.

According to the sensor cleaning device and the image forming apparatus including the same according to the present disclosure, the cleaning lever is positioned in the housing and does not affect the movement of the printing medium passing through the transferring path, and the sensor may be cleaned automatically when no copying or printing operation is performed.

Further examples of the present disclosure are described below.

A sensor cleaning device according to further examples of the present disclosure may clean a sensor for detecting a printable medium on a transferring path, the sensor cleaning device may include a cleaning lever coupled to a cleaner at an end and a driver coupled to the cleaning lever to drive the cleaning lever to move the cleaner from a first position to a second positon and back to the first position, the first position being away from the transferring path and the second position being in contact with the sensor.

According to further examples of the present disclosure, the sensor cleaning device may further include a guide rail disposed adjacent to the transferring path and a guide projection part coupled to the cleaning lever in contact with the guide rail to guide movement of the cleaning lever.

According to further examples of the present disclosure, the guide rail may include a first rail inclined to the transferring path to protrude the cleaning lever and a second rail parallel to the transferring path to guide the cleaning lever so the cleaner is to contact the sensor and clean the sensor.

According to further examples of the present disclosure, the sensor cleaning device may further include a lever spring to provide the cleaning lever with restoring force in the first position direction.

According to further examples of the present disclosure, the sensor cleaning device may further include a guide block located adjacent to the guide rail to guide movement of the cleaner.

According to further examples of the present disclosure, the driver may include a guide plate coupled to a driving lever to drive the cleaning lever, and a movable driving shaft insertable into a driving groove located in the guide plate, the guide plate being movable to a driving guider.

According to further examples of the present disclosure, the driving guider may include a guide shaft disposed along a direction of the first position and the second position, wherein the guide shaft being insertable to a guide groove formed to the guide plate.

An image forming apparatus according to further examples of the present disclosure may include a sensor disposed toward a transferring path on a first side of the transferring path to which a printing medium is moved and a cleaning device including a cleaning lever coupled to a cleaner to clean the sensor, and a driver coupled to the cleaning lever to drive the cleaning lever.

According to further examples of the present disclosure, the cleaner may move from a first position to a second position and back to the first position, the first position being away from the transferring path and the second position being in contact with the sensor.

According to further examples of the present disclosure, the image forming apparatus may further include a second sensor disposed toward the transferring path on a second side of the transferring path to which a printing medium is moved, the second side being different from the first side. The sensor may include a light emitting portion disposed on the first side of the transferring path to irradiate light toward the printing medium and the second sensor comprises a light receiving portion disposed on a second side of the transferring path to face the light emitting portion, and the cleaner may clean the light emitting portion and/or the light receiving portion.

According to further examples of the present disclosure, the first position may be the position where the cleaner and the cleaning lever deviate from the transferring path so as not to interfere with the movement of the printing medium.

According to further examples of the present disclosure, the second position may be the position on the transferring path where the cleaner cleans the light emitting portion and/or the light receiving portion.

According to further examples of the present disclosure, the image forming apparatus may include a processer to detect operating states of the light emitting portion and the light receiving portion and control an operation of the driver.

According to further examples of the present disclosure, the processer may control the operation of the driver so that the cleaner is in the first position when the printing medium passes on the transferring path, and the cleaner is in the second position to clean the sensor if there is no printing medium on the transferring path.

According to further examples of the present disclosure, the image forming apparatus may further include a memory to communicate with the processer.

According to further examples of the present disclosure, the processer may operate the driver when a number of operations stored in the memory exceeds a predetermined number of operations or when a sensitivity of the light emitting portion or the light receiving portion is less than a predetermined sensitivity.

According to further examples of the present disclosure, the image forming apparatus may further include a guide rail disposed to adjacent the transferring path and a guide projection part coupled to the cleaning lever to contact the guide rail to guide movement of the cleaning lever.

According to further examples of the present disclosure, the guide rail may include a first rail inclined to the transferring path to protrude the cleaning lever and a second rail parallel to the transferring path to guide the cleaning lever so the cleaner is to contact the sensor and clean the sensor.

While this disclosure has been described in connection with what is presently considered to be practical examples, it is to be understood that the disclosure is not limited to the disclosed examples. On the contrary, it is intended to cover various modifications and equivalent arrangements included within the spirit and scope of the appended claims.

What is claimed is:

1. A sensor cleaning device to clean a sensor to detect a printable medium on a transferring path, the sensor cleaning device comprising:
a cleaning lever coupled to a cleaner at an end of the cleaning lever; and
a driver coupled to the cleaning lever to drive the cleaning lever to move the cleaner from a first position to a second position and back to the first position, the first position being away from the transferring path and the second position being in contact with the sensor.

2. The sensor cleaning device of claim 1, further comprising:
a guide rail disposed adjacent to the transferring path; and
a guide projection part coupled to the cleaning lever to contact the guide rail to guide movement of the cleaning lever.

3. The sensor cleaning device of claim 2, wherein the guide rail comprises:
a first rail inclined to the transferring path to protrude the cleaning lever; and
a second rail parallel to the transferring path to guide the cleaning lever so the cleaner is to contact the sensor and clean the sensor.

4. The sensor cleaning device of claim 1, further comprising a lever spring to provide the cleaning lever with restoring force in a direction of the first position.

5. The sensor cleaning device of claim 1, further comprising a guide block located adjacent to the guide rail to guide movement of the cleaner.

6. The sensor cleaning device of claim 1, wherein the driver comprises a guide plate coupled to a driving lever to drive the cleaning lever, and a movable driving shaft insertable into a driving groove located in the guide plate, the guide plate being movable relative to a driving guider.

7. The sensor cleaning device of claim 6, wherein the driving guider comprises a guide shaft disposed along a direction of the first position and the second position,
wherein the guide shaft being insertable to a guide groove is formed to the guide plate.

8. An image forming apparatus comprising:
a sensor disposed toward a transferring path on a first side of the transferring path to which a printing medium is moved; and
a cleaning device comprising a cleaning lever coupled to a cleaner to clean the sensor, and a driver coupled to the cleaning lever to drive the cleaning lever to move the cleaner from a first position to a second position and back to the first position, the first position being away from the transferring path and the second position being in contact with the sensor.

9. The image forming apparatus of claim 8, wherein the image forming apparatus further includes a second sensor disposed toward the transferring path on a second side of the transferring path to which a printing medium is moved, the second side being different from the first side,
wherein the sensor comprises a light emitting portion disposed on the first side of the transferring path to irradiate light toward the printing medium and the second sensor comprises a light receiving portion disposed on a second side of the transferring path to face the light emitting portion, and
wherein the cleaner is to clean the light emitting portion and/or the light receiving portion.

10. The image forming apparatus of claim 8, wherein the first position is the position where the cleaner and the cleaning lever deviate from the transferring path so as not to interfere with the movement of the printing medium.

11. The image forming apparatus of claim 9, wherein the second position is the position on the transferring path where the cleaner is to clean the light emitting portion and/or the light receiving portion.

12. The image forming apparatus of claim 9, further comprising a processer to detect operating states of the light emitting portion and the light receiving portion and control an operation of the driver,
wherein the processer is to control the operation of the driver so that the cleaner is in the first position when the printing medium passes on the transferring path, and the cleaner is in the second position to clean the sensor if there is no printing medium on the transferring path.

13. The image forming apparatus of claim 12, further comprising a memory to communicate with the processer,
wherein the processer operates the driver when a number of operations stored in the memory exceeds a predetermined number of operations or when a sensitivity of the light emitting portion or the light receiving portion is less than a predetermined sensitivity.

14. The image forming apparatus of claim 8, further comprising:
a guide rail disposed adjacent to the transferring path; and
a guide projection part coupled to the cleaning lever to contact the guide rail to guide movement of the cleaning lever.

15. The image forming apparatus of claim 14, wherein the guide rail comprises:
a first rail inclined to the transferring path to protrude the cleaning lever; and
a second rail parallel to the transferring path to guide the cleaning lever so the cleaner is to contact the sensor and clean the sensor.
